(19) United States
(12) Patent Application Publication
(10) Pub. No.: US 2008/0209755 A1
(43) Pub. Date: Sep. 4, 2008

(54) Counter flow cooling drier with integrated heat recovery with fluid recirculation system

(76) Inventor: Steve D. Shivvers, Prole, IA (US)

Correspondence Address: LAW OFFICE OF JOHN C. MCMAHON, P.O. BOX 30069, KANSAS CITY, MO, 64112, US

(21) Appl. No.: 12/011,305

(22) Filed: Jan. 25, 2008

Related U.S. Application Data
(60) Provisional application No. 60/897,717, filed on Jan. 26, 2007.

(51) Int. Cl. F26B 3/06; F26B 11/02; F24H 3/00

(52) U.S. Cl. 34/363; 34/598; 165/47

(57) ABSTRACT

A drier apparatus for removing water from various materials includes a heating portion, a drying chamber, a first fluid recirculation system, a regenerator and a makeup heater. Also, a method for use of the apparatus. The material to be dried is heated with the first fluid and transferred to the drying chamber. The material is passed counterflow through the drying chamber relative to a second fluid. The second fluid upon exiting the drying chamber is used to preheat the first fluid.

### CROSS REFERENCE TO RELATED APPLICATIONS

This application claims the benefit of U.S. Provisional Application No. 60/897,717, filed Jan. 26, 2007 which is incorporated herein by reference.

### STATEMENT REGARDING UNITED STATES GOVERNMENT SPONSORED RESEARCH OR DEVELOPMENT

The present invention was at least in part made with support from the United States Government under Contract No. 2005-33610-15517 awarded by the USDA SBIR. The United States Government has certain rights in the invention.

### BACKGROUND OF THE INVENTION

The present invention is directed to improvements in driers and methods of drying used to dry various materials, including newly harvested grain, wood pellets, as well as a wide range of materials and, in particular, to driers that recover and utilize a comparatively high percentage of the energy used in the drying process.

The drying industry is very large and utilizes significant amounts of both fossil fuels and electricity to dry various materials. While the grain industry is not the only industry that requires significant drying, it is indicative of the problems that exist. Just the U.S. corn crop amounts to over nine billion bushels annually. Moisture must be removed in order to allow the grain to be stored without significant loss due to mold, mildew and rot, all that are caused by excess retained moisture.

In theory, each pound of water removed from the grain has a latent heat of vaporization of about 1160 British thermal units (Btu) per pound. In a highly effective drier system, the drier could import exactly this theoretical amount of energy per pound of water to be removed from the grain. In reality, conventionally heated air dryers exhaust warm air and often the material being dried exits the dryer warmer then it enters the dryer leading to inefficient use of energy input. Cross flow grain driers usually require more than 2000 Btu per pound of water removed versus the theoretical amount of 1060 Btu per pound.

Because the corn industry in the U.S. consumes approximately 900 million gallons of propane and over 3200 million kilowatt-hours of electricity per year just to dry the corn and because this produces nearly two million tons of carbon dioxide exhaust gases per year, it is seen that any improvement in drying efficiency can amount to significant savings in fuel, energy and emissions. Corn is only one type of grain that must be dried. Further, there are many other solids, semi-solids and initially liquid compositions that are dried each year at considerable costs in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may produce a final product that has an average moisture content that is within a desired level, the moisture may not be consistent. Consequently, problems are encountered especially in many types of conventional grain cross flow driers, where the grain is heated and dried by air passing perpendicularly to the flow of the grain. In such driers, the grain on the side of the drier that first encounters the heated air is overly dried and may be dried too quickly or cooled too quickly causing cracking and the grain on the opposite or air discharge side tends to exit the drier too wet.

### SUMMARY OF THE INVENTION

A drier for drying wet, especially particulate material such as harvested grain, wood pellets and the like, as well as wet materials and initially semi solid materials of all types, especially such material that would easily absorb appreciably more moisture, if exposed to such moisture, using a highly efficient apparatus that recovers and reuses a substantial amount of the heat used in the drying process.

The drier includes a heating region or portion, a drying chamber, a regenerator, a first fluid recirculation system, a second fluid circulation system and a make up heater. The drier maintains the second fluid segregated or separate from the first fluid, however, the second fluid may have the same composition as the first fluid. The second fluid carries the water vapor away from and thereby dries the material in the drying chamber.

Wet material, such as grain, is fed into the heating portion wherein the first fluid in a warm state is counter flow circulated by the first fluid recirculation system through the material, so as to initially heat the material.

The first fluid recirculation system also circulates the first fluid in a closed loop through the regenerator after heating the material and as the first fluid enters the regenerator the first fluid is in a comparatively cool state. The first fluid is heated by heat transferred to the first fluid from the second fluid, including the latent heat of vaporization by condensation of water vapor from the second fluid, in the regenerator. In this manner, the first fluid is segregated from the second fluid and does not transfer moisture from the second fluid to the material to be dried. Preferably the regenerator is a conventional heat exchanger adapted to allow moisture formed as condensate, when the second fluid cools, to drain from the regenerator, although other devices may be utilized.

The material exits the heating portion and enters a first end of the drying chamber in a comparatively warm and wet state. The material flows through the drying chamber and exits at a second end in a relatively drier and cooler state as compared to entry into the drying chamber and is in a drier state in comparison to entry of the material into the drier. The material may not be completely dried in single passage through the chamber, but is reduced in moisture content by a significant percentage, which may be sufficient to meet the drying requirements, or the material may be passed through the drier multiple times.

The second fluid enters the drier near the second end and passes counter flow or countercurrent through and directly adjacent to the material to near the drier first end. The second fluid thereby becomes warmer and wetter and at least partially saturated by passage through the material in the chamber. The second fluid exiting the drying chamber is then conveyed to the regenerator to heat the first fluid, as described above.

The drying chamber may be any suitable device for holding the material for a holding period sufficient for substantially adiabatic vaporization and evaporative cooling to occur, especially a continuous flow pass through type chamber. Suitable drying chambers includes vertical columns and rotating drums or tubes that are effective in conveying the material so as to interface with the second fluid to transfer both moisture and heat from the material to the second fluid while in the chamber.

The make up heater can be effectively located at different locations within the drier and is preferably at the flow exit of the first fluid from the regenerator. The make up heater has as a purpose to bring the temperature of the material entering the drying chamber to a level that will evaporate or drive the selected amount of moisture from the material to be carried away by the first fluid, while in the chamber. The material is mainly heated by the heat received from the first fluid. The makeup heater may alternatively be located so as to add heat directly to the material between the heating portion and the drying chamber or a second stream of heated material can be combined with the flow of material from the heating portion to supply additional heat to the process, or otherwise located to supply makeup heat in an effective manner.

In embodiments of the invention wherein the second fluid absorbs or carries components of the material to be dried, such as excessive dust, that may present an emissions or environmental problem, the second fluid can be recycled from the discharge of the regenerator back to the second end of the drying chamber provided that a method, such as a chiller or heat pump, is used to assure that the temperature of said fluid is decreased to a selected temperature, such as 70° F. prior to reintroduction to the drying chamber. A heat pump has the advantage of recapturing the energy removed from the recycled second fluid for reintroduction to the first fluid between the regenerator and heating portion or to the material to be dried between the heating portion and the drying chamber, or the like. If the temperature of the recycled second fluid is not reduced between the regenerator and drying chamber, the drying potential of the chamber can be markedly decreased. Therefore, for most embodiments using second fluid recycle, a chiller is provided in the recycle system to lower the temperature of the second fluid to a selected temperature, such as 70° F. The temperature of the recycling second fluid may also be reduced through use of a heat pump that in turn conveys removed heat to the first fluid between the regenerator and heating portion or to the material between the heating portion and the drying chamber, or the like. In most instances, the first and second fluids are both air and the second fluid is normally ambient air, although in some instances, other fluids, including gases, such as nitrogen, and liquids can be used in the drier.

The present invention has the advantage of providing a drying system that is consistent, efficient, produces uniform drying and is non stressful to materials that are subject to stress. The drying system can also advantageously reduce discharge of dust and other emissions in certain embodiments.

### OBJECTS AND ADVANTAGES OF THE INVENTION

Therefore, the objects of the invention are: to provide a drier that is especially effective in drying material with comparatively lower outside energy input in comparison to conventional driers; to provide such a drier that is effective in uniformly and consistently drying materials, especially granular materials such as grain, wood pellets or the like; to provide such a drier that initially heats the material to be dried by passing a heated first fluid through the material and then passing the heated material counterflow with respect to a second drying fluid through a drying chamber wherein, the second fluid, such as air, is initially comparatively cool and preferably unsaturated, so that the second fluid is heated and at least partially saturated with moisture as the second fluid passes through the material; to provide such a drier wherein the second fluid exiting the drying chamber is utilized to pre-heat the first fluid in a regenerator; to provide such a drier that is used in certain embodiments so as to have closed recycle of the second fluid to reduce undesirable emissions and/or conserve the second fluid; to provide such a drier that has a comparatively high efficiency such that comparatively little heat is required from an external source, such as fossil fuel, in comparison to conventional driers; and to provide such a drier that is easy to use, economical to build and operate and especially well adapted for the intended purpose thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a partially schematic view of a drier in accordance with the present invention having a vertical drying chamber.

FIG. 2 is a first modified drier similar to that of FIG. 1 having a drying fluid recycle system and a fluid chiller.

FIG. 3 is a partially schematic view of a second modified drier in accordance with the present invention having a rotary drying chamber.

FIG. 4 is a third modified drier similar to the drier of FIG. 3 having a drying fluid recycle system and a drying fluid chiller.

FIG. 5 is a partially schematic view of a fourth modified drier in accordance with the present invention that is similar to the drier of FIG. 1, but has a cross flow makeup heater.

FIG. 6 is a fifth modified drier similar to the drier of FIG. 5 having a drying fluid recycle system and a drying fluid chiller.

FIG. 7 is a partially schematic view of a sixth modified drier in accordance with the present invention having a rotary drying chamber and a cross flow supplemental makeup heater.

FIG. 8 is a seventh modified drier similar to the drier of FIG. 7 having a drying fluid recycle system and a drying fluid chiller.

FIG. 9 is a schematic diagram of a further alternative drying chamber wherein a mixture to be dried enters one end of the chamber and a drying fluid flows generally overall counterflow to the mixture, but in stages flows concurrently with the mixture.

FIG. 10 is a schematic diagram of a still further alternative drying chamber wherein a mixture to be dried enters one end of the chamber and a drying fluid flows generally overall counterflow to the mixture, but in stages flows cross flow relative to the mixture.

FIG. 11 is a schematic diagram of a yet further alternative drying chamber wherein a mixture to be dried enters one end of the chamber and drying fluid flows generally overall counterflow to the mixture, but in stages the drying fluid flows in mixed flow patterns relative to the mixture.

FIG. 12 is a schematic of a further alternative heating portion wherein a mixture to be heated enters from one end and comparatively hot fluid flows overall generally counterflow to the mixture, but in stages the fluid flows concurrently with the media.

FIG. 13 is a schematic of a still further alternative heating portion wherein a mixture to be heated enters from one end and comparatively hot fluid flows generally overall counter currently to the media, but in stages the fluid flows in cross flow through the mixture.

FIG. 14 is a schematic of a yet further alternative heating portion wherein a mixture to be heated enters from one end and comparatively hot fluid flows generally overall counter current to the mixture, but in stages fluid flows in mixed flow patterns relative to the media.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

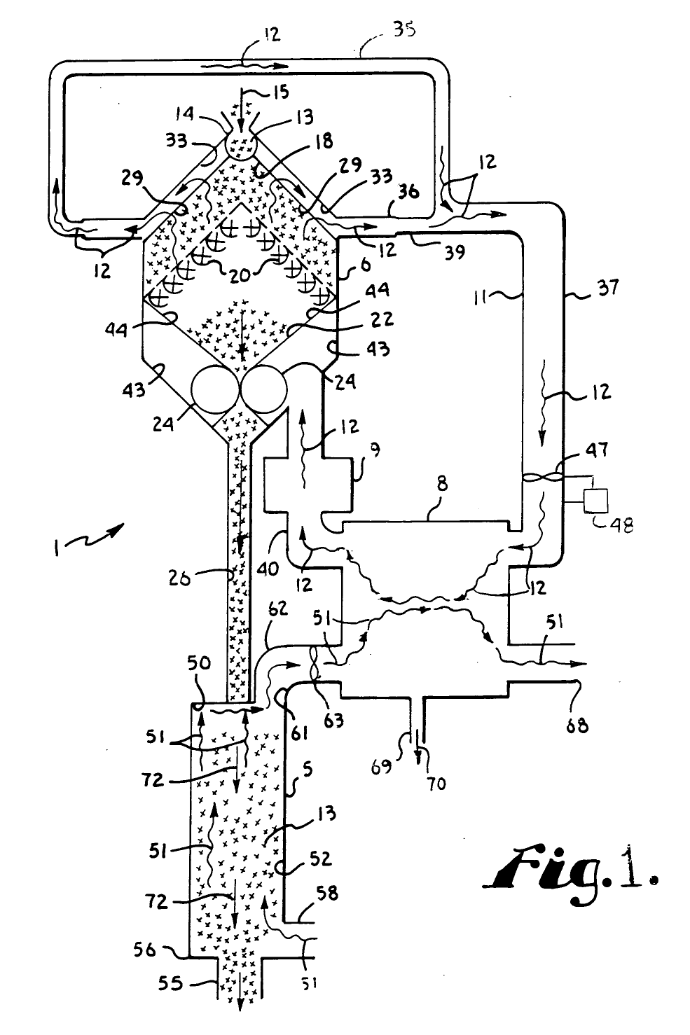

Illustrated in FIG. 1 is a particulate material drier, generally identified by the reference numeral 1. The drier 1 has a lower drying chamber 5 and upper receiving or heating portion 6, a regenerator 8 and a makeup heater 9. The drier 1 also includes a first fluid recirculation system 11.

Particulate material 13 generally represented by x's throughout the process, enters the top of the drier heating portion 6 through a feeder 14 and flow of the material 13 is identified by a reference arrow 15 and in general by other straight arrows throughout the drier 1. The particulate material 13 may be any of numerous types of materials that require drying, including grain, wood pellets and the like. The present invention is especially suited for drying materials 13 that may easily absorb significant amounts of additional moisture, if exposed to such. The particulate material 13 passes through the feeder 14 into a first heating region 18. The material 13 is fed from a lower end of the first heating region 18 by metering rolls 20 into a second heating region 22. The material 13 exits a lower end of the second heating region 22 into a pair of sponge rollers 24, providing sufficient restriction to operably function as an airlock, while not applying too much pressure to the material 13 so as to break or damage the material 13 during the process. The material 13 passes from the rollers 24 into a vertical chute 26.

It is foreseen that the heating region or portion of the drier could be constructed in numerous ways that would provide for the basic requirement of containing the material while heated fluid passes through the material.

The heating portion 6 also includes a first series of upper walls 29 that are located above the heating region 18. The walls 29 are perforated in such a manner as to have apertures that are sized sufficiently to allow passage of a fluid, which is preferably air, therethrough. The apertures of the walls 29 are also sufficiently small so as to prevent passage of the material 13 therethrough. In operation, as will be discussed below, a first fluid is generally located in and circulating through the heating portion 6 and in the first fluid recirculation system 11. The first fluid is identified by squiggly arrows, such as arrows 12, and passes generally upwardly through the material 13 within the regions 22 and 18. The first heating fluid thus passes upwardly through the walls 29 and into collection plenums or conduits 33. The conduits 33 are in turn flow connected to collection conduits or piping 35 and 36 and thereafter the first fluid 12 is conveyed to a main conduit 37.

The main conduit 37 flow conveys the first fluid into the regenerator 8. The regenerator 8, in this embodiment, is a shell and tube heat exchanger and the first fluid passes through the tube side of the regenerator 8. The first and second fluids never mix with one another in the regenerator 8, but rather only exchange heat therebetween. The first fluid 12 exits the regenerator 8 through a return conduit 40. Positioned along the return conduit 40 in heat exchange relationship with the first fluid 12 is the makeup heater 9. The return conduit 40 flow connects with the lower end of the heating portion 6 and, in particular, with a pair of opposed lower plenums 43 located on opposite sides of the rollers 24.

A lower wall 44 of the region 22 is also perforated in such a manner as to allow passage of the first fluid 12 through, but so as to prevent passage of the material 13 therethrough. The first fluid 12 flows through the lower wall 44 and into the material 13 located within the regions 18 and 22. Thus, the first fluid recirculation system 11 comprises the second region 22, the first region 18, the upper collection conduits 33, the collection piping 35 and 36, the main conduit 37, the regenerator 8 and the return conduit 40 in conjunction with the makeup heater 9.

The makeup heater 9 is for the purpose of adding additional heat to the system which is lost during the process. While the overall process is highly efficient in recovery of heat and, therefore, it requires less makeup than conventional systems, some heat is still lost in the processing and must be made up to the system. While the makeup heater 9 is shown positioned between the regenerator 8 and the heating portion 6 and in the first fluid return line 40, it is foreseen that it could be positioned in various locations throughout the process. For example, it is foreseen that a makeup heater could be utilized to add heat to the material 13 after exiting the sponge rollers 24.

A fan 47 drives by either pushing or pulling the first fluid 12 throughout the recirculation system 11. A fluid recirculation controls 48 operably measures the temperature of the fluid 12 at various location and acting in conjunction with the make up heats 9 and circulation fan 47 controls the temperature of the fluid 12 entering the particulate material 13. It is foreseen that the fan 47 could be located in various places throughout the recirculation system 11, such as in the return conduit 40.

The drying chamber 5 is a vertical column and receives the particulate material 13 from the chute 26 into an upper first end 50 thereof. The chamber 5 can be of many different types and the chamber 5 of the present embodiment is an elongate vertically aligned rectangular structure with a drying region 52.

It is foreseen that the chamber 5 can be almost horizontally aligned and rotary or one of many different types of chamber configurations of the types used as dryers. The chamber 5 has a lower outlet 55 for discharge of the material 13 therefrom. Preferably, the level of the material 13 is maintained within the chamber 5 generally so as to keep the chamber 5 full to or near the first end 50. The outlet 55 is located at the chamber second end 56.

Also located at or near the chamber second end 56 is a second fluid inlet 58. Positioned across the inlet 58 is a screen or mesh structure having an opening size sufficiently small to prevent passage of material 13 from the chamber 5 through the inlet 58, but allowing passage of the second fluid 51 therethrough. Located at or near the chamber first end 50 is an outlet 61 for the second fluid 51. The outlet 61 flow connects with a conduit 62 having a fluid driving fan 63 therein. The conduit 62 also joins with the shell side of the regenerator 8 so as to allow passage of the second fluid 51 through the regenerator 8. The second fluid 51 is allowed to discharge from the regenerator 8 through a discharge outlet 68 into the ambient atmosphere. The shell side of the regenerator 8 includes a liquid collection and discharge tube or drain 69 for discharging condensate collected within the regenerator 8 as liquid and indicated by the reference numeral 70.

During use of the drier 1, as the material 13 flows from the first end 50 to the second end 56 of the chamber 5 which is indicated by the reference arrows 72, the second fluid identified by the arrows having reference numeral 51, flows generally from the second end 56 to the first end 50 of the chamber 5, countercurrent to the flow of the material 13 therethrough. In this manner, the material 13 that has been heated in the drier heating portion 6 enters the chamber 5 both comparatively warm and wet. As the material 13 flows through the chamber 5 it mixes with relatively cool and preferably unsaturated ambient air (the second fluid 51) that is passing countercurrent to the material 13, such that the material 13 becomes comparatively drier and cooled during the passage through the chamber 5, while the second fluid 51 become comparatively warmer and preferably saturated with moisture.

The material 13 exits the outlet 55 with reduced moisture as compared to the material 13 that enters the chamber 5 from the chute 26. The comparatively warm and wet second fluid 51 exits the drier 5 and enters the regenerator 8. In the regenerator 8, the second fluid 51 is in direct heat transfer contact with the first fluid 12, so as to exchange or transfer heat from the second fluid 51 to the first fluid 12, but the first and second fluids do not mix together. Also, while in the regenerator 8, the second fluid 51 becomes cooler such that condensate forms on the shell side of the heat exchanger of the regenerator 8, so that moisture 70 collects within the regenerator 8 and is discharged through the drain 69.

In embodiments where the physical and thermal properties of the first and second fluids are similar, the flow rate of the second fluid is comparatively lower than that of the first fluid. The second fluid is primarily a carrier of water vapor. As material 13 flows through chamber 5, heat energy is utilized to evaporate water in an adiabatic process causing the material temperature to decrease. As the second fluid passes through chamber 5 in direct contact with material 13, the water vapor is picked up by the second fluid and the second fluid increases in temperature in response to the vapor and material temperature. It is important to minimize the cooling effect of the second fluid upon material 13 so that the heat energy imparted by heating regions 18 and 22 is utilized by the adiabatic vaporization process and is not wasted in raising the temperature of an excess of second fluid. This also ensures near saturation of the second fluid when it enters regenerator 8 and makes possible recapture of latent heat of vaporization through condensation within the regenerator 8.

Thus, the overall process is that the comparatively wet material 13 enters the heating portion 6 wherein the recycling first fluid 12 heats the material 13, the material 13 passes to the drying chamber 5 wherein the material 13 undergoes an adiabatic process of evaporation of moisture with associated evaporative cooling while flowing countercurrently to an incoming comparatively cool and dry second fluid 51, such that the second fluid 51 carries the evaporated moisture away from the material 13, and the second fluid 51 becomes warmer and at least partially saturated while passing through chamber 5. The second fluid 51 exits the chamber 5 and transfers at least a substantial portion of the latent heat obtained from drying the material and conveyed by the vapor in the second fluid 51 to the first fluid 12 in the regenerator. Any additional heat or energy required of the system to meet the desired energy for drying through sensible heat increase of the material is supplied by the makeup heater 9.

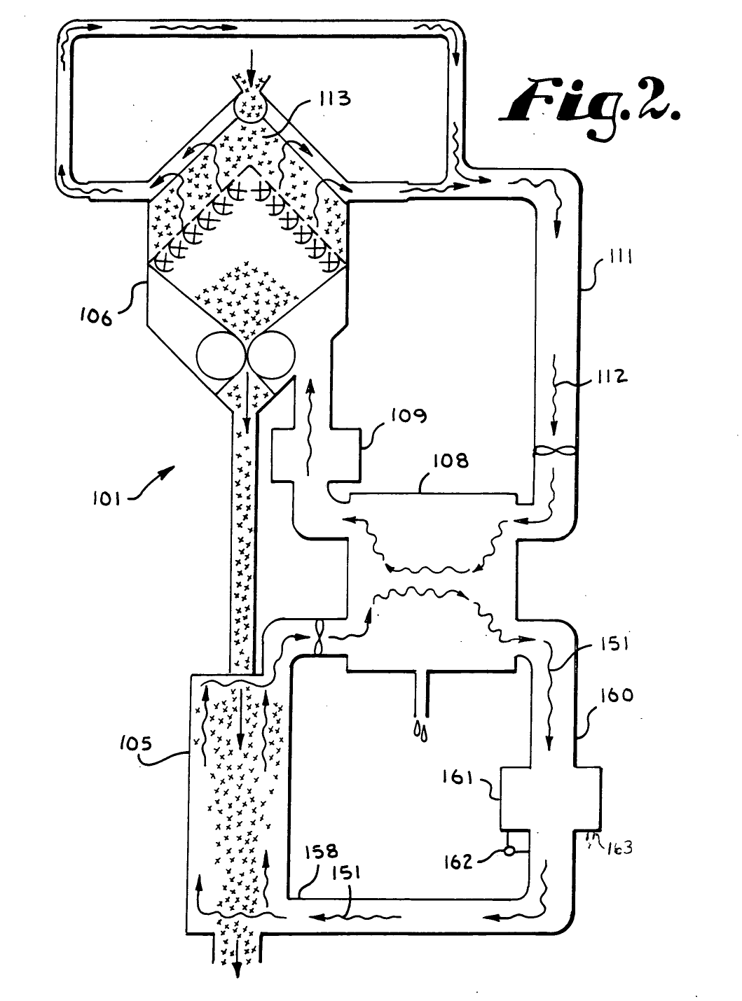

Illustrated in FIG. 2 is a first modified embodiment of a drier in accordance with the present invention which is generally identified by the reference number 101. The drier 101 is in many ways quite similar to the drier 1 and, therefore, only the major differences between the driers will be discussed in great detail. References is made to drier 1 for a more detailed description of the various elements and functions of the drier 101.

The drier 101 includes a drying chamber 105, a heating portion 106, a regenerator 108, a makeup heater 109 and a first fluid recirculation system 111. A first fluid 112 circulates through the first recirculation system 111 as described for fluid 12 recirculating through the recirculation system 11 of the previous embodiment and heats comparatively wet particulate material 113 within the heating portion 106. The heated material 113 is transferred to the drying chamber 105 wherein a second fluid 151 flows in counterflow to the material 113 so as to both cool and dry the material 113. During passage through the chamber 105, the second fluid 151 becomes heated and at least partially saturated. Upon exiting the chamber 105, the second fluid 151 is cooled below its dew point and condenses water vapor while transferring heat the first fluid 112 in the regenerator 108 without direct contact with the fluid 112. Upon exiting the regenerator 108, the second fluid 151 enters a recycle conduit 160 which is different from the previous embodiment. The recycle conduit 160 flow communicates between the regenerator 108 and an inlet 158 of the second fluid 151 into the drying chamber 105. Thus the second fluid 151 is not released to the atmosphere, which may be advantageous in such situations where the fluid 151 carries dust or other potential emissions from the material 113. Because the second fluid 151 is in a closed loop, there are certain circumstances where the fluid 151 would continue to increase in temperature at the inlet 158 with each cycle. Such increase in temperature would reduce the efficiency. Consequently, a chiller 161 is utilized in conjunction with the recirculating second fluid 151. A controller 162 determines the temperature of the second fluid 151 exiting the chiller 161 and adjusts the chilling as required within the chiller 161 to reach a preselected temperature, for example 700F. The chiller 161 can be of any type of conventional cooling unit. It is foreseen that devices such as heat pumps may be used to effectively chill or cool the returning second fluid 151 to a desired starting temperature. Condensate 163 that collects in the chiller 161 is preferably discharged through a drain or the like.

Illustrated in FIG. 3 is a second modified embodiment of a drier 201 in accordance with the present invention. The drier 201 has numerous elements which are the same as the drier 1 and, therefore, these elements are not described in detail with respect to this embodiment. References made to drier 1 for additional description of structure and function.

The drier 201 includes a drying chamber 205, a heating portion 206, a regenerator 208, a makeup heater 209 and a first fluid recirculation system 211. A first fluid 212 flows through the recirculation system 211 to heat comparatively wet particulate material 213 in the heating portion 206. The first fluid 212 is at least partially heated by a second fluid 251 that is discharged from the drying chamber and flows into the regenerator 208. The first fluid 212 after being preheated by the second fluid 251 is heated to a preselected temperature by the makeup heater 209 and then circulated through the material 213 in the heating chamber 206 so as to heat the material 213 therein.

The present embodiment differs from the embodiment shown in FIG. 1 and, in particular to drier 1, in that the drying chamber is of a different type. The principal difference between the present embodiment and that of FIG. 1 is that the drying chamber 205 of the present embodiment differs from the drying chamber 5 of the drier 1. In particular, the drying chamber 205 is an elongate rotary drier which has an inlet at a first end 250 and has a material discharge 255 at a second end 256 thereof. The drier chamber 205 is generally cylindrical in shape and slopes downwardly from the first end 250 to the second end 256 so as to urge the material 213 to flow from the first end 250 to the second end 256, as is indicated by the reference arrow 273, as the chamber 205 rotates, such as is indicated by the reference arrow 272. Ambient air 251, as a second fluid, is drawn into the chamber 205 at the second end 256 thereof through an inlet 258. The air 251 flows countercurrent from the chamber second end 256 to the first end 250 past and through the material 213 in the chamber 205 so as to remove moisture from the material 213, while being warmed thereby. The air 251 exits the chamber 205 through an outlet 261 and is conveyed through the regenerator 206 by the fan 263.

As noted, the air 251 in the regenerator 208 condenses moisture and preheats the first fluid 212 without direct contact with the first fluid 212. Located in the chamber 205 are a series of radially aligned plates 280 which do not rotate with the remainder of the chamber 205. The plates 280 segment and form the upper portion of the chamber 205 into a series of smaller segments 281 which allow for circulation of the air 251 therethrough. The material 213 flows beneath the lower edges 282 of the plates 280.

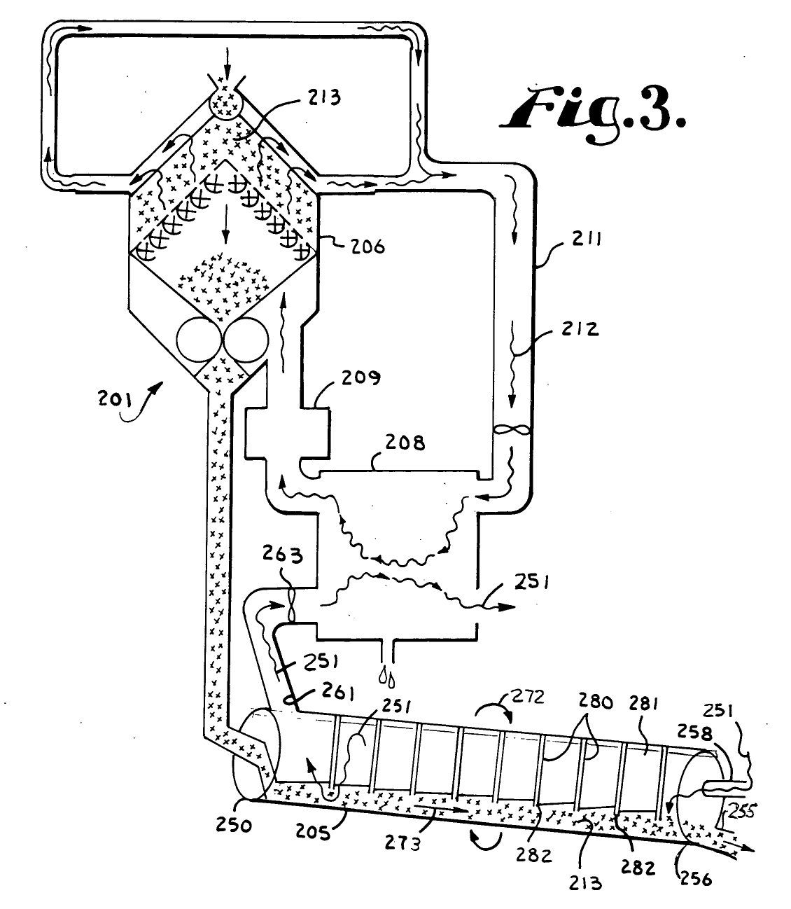

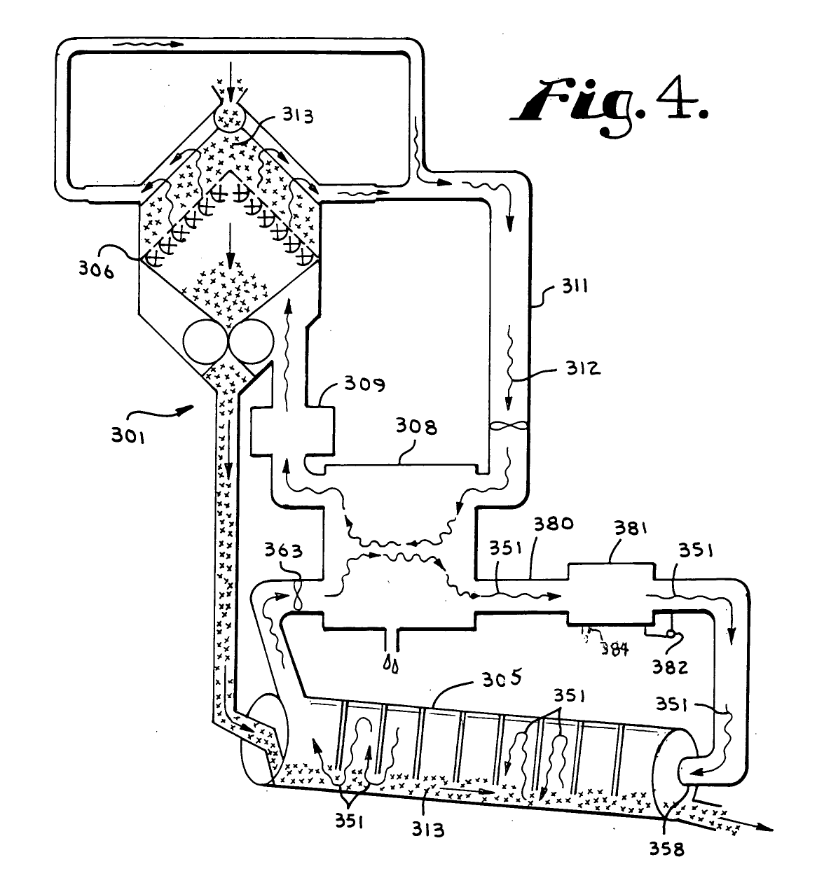

Illustrated in FIG. 4 is a third modified embodiment of a drier in accordance with the present invention which is generally identified by the reference numeral 301. The embodiment illustrated in FIG. 4 is quite similar to the embodiment illustrated in FIG. 3, except as described below. Consequently, references made to both the description of the drier 201 and the description of the drier 1 for detail concerning the structure and function of the drier 301, not otherwise described below.

The principal difference between the drier 301 as compared to the drier 201 is that a second fluid 351 is recycled rather than discharged into the atmosphere. This embodiment is especially useful in conjunction with driers that are drying material that has a high dust content or other content that could create emission problems if discharged directly into the atmosphere.

The drier 301 includes a drying chamber 305, a heating portion 306, a regenerator 308, a makeup heater 309 and a first fluid recirculation system 311. A first fluid 312 recirculates through the recirculation system 311 and heats material 313 in the heating portion 306. A makeup heater 309 adds makeup heat required by losses in the process to the recirculating first fluid 312 and the first fluid 312 is preheated by the second fluid 351 in the regenerator 308.

The second fluid 351 of the present embodiment discharges from the regenerator 308 into a recirculation conduit 380 which flow communicates with a drying chamber first fluid inlet 358. In this manner, the second fluid 351 is flowed through the chamber 305 counterflow to the material 313 by a fan 363 so as to enter the regenerator 308 both comparatively warm and wet from moisture and heat from the material 313 being dried. The second fluid 351 which is preferably air, but which can be other fluids in accordance with the invention flows through the regenerator 308 so as to preheat the first fluid 312 and thereafter cycles back to the chamber 305. During passage through the recycle conduit 380, the fluid 351 passes through a chiller 381 for the purpose of cooling the fluid 351 to a preselected temperature such as 70° F. under control of a controller 382. In this manner, the temperature of the second fluid 351 coming into the chamber 305 does not increase with each cycle so as to make the system inefficient. Condensate from the second fluid 351 that collects in the chiller 381 is discharged through a drain 384 or the like.

Shown in FIG. 5 is a fourth modified embodiment of a drier in accordance with the present invention generally identified by the reference numeral 401. The drier 401 is similar in most aspects to the drier 1 of FIG. 1. Consequently, not all elements of the drier 401 are reiterated extensively herein, but rather reference is made to the description of drier 1 for various elements, structure and function which are not described below.

The drier 401 includes a drying chamber 405, a heating portion 406, a regenerator 408, a makeup heater 409 and a first fluid recirculation system 411. A first fluid 412 is circulated through the first fluid recirculation system 411 to operably heat material 413 to be dried in the heating portion 406. As with the previously mentioned embodiment, the material 413 flows through a chamber 405 counterflow to a second fluid 451, here air, so that the air 451 becomes heated and at least partially saturated and so that the material 413 becomes dryer as the material 413 passes through the chamber 405. The second fluid 451 exits the chamber 405 and enters the regenerator 408 to preheat the first fluid without mixing therewith and is discharged into the atmosphere.

The principal difference between this embodiment and that shown in FIG. 1 is that the makeup heater 409 is positioned so as to directly heat the material 413 exiting the heating portion 406. A chute 426 through which the material 413 passes is perforated so as to allow passage of heated air as indicated by the open headed arrows 490 therethrough. That is, the heater 409 heats the air 490 which in a heated state is cross flowed through the material 413 in the chute 426 so as to heat the material 413 such that at a bottom 492 of the chute 426 the material 413 is at a preselected temperature. The preselected temperature may encompass a range of temperatures. Preferably, the heated air 490 after being utilized to heat the material 413 in the chute 426 is returned to the heater 409 for reheating. The preselected temperature varies with the type of material being heating and is selected so as to not to cause cracking or damage to the material. For example, the selected temperature for some materials 413 may be approximately 140° F. The present embodiment functions like the drier 1 other than that the makeup heat is applied directly to the material 413 by the heater 409 rather than to the circulating first fluid 412.

FIG. 6 illustrates a fifth modified embodiment of a drier in accordance with the present invention generally identified by the reference numeral 501. The drier 501 is quite similar to the drier 401 of the previously described embodiment and of the drier 101 of FIG. 2. Consequently, the portions of the present drier 501 that are different will be described in detail and references is made to the description for driers 401 and 101 for other specific detail concerning the structure and function of the various elements of the drier 501.

The drier 501 includes a drying chamber 505, a heating portion 506, a regenerator 508, a makeup heater 509 and a first fluid recirculation system 511. A first fluid 512 is circulated by the first fluid recirculation system 511 through material 513 to be dried in the heating portion 506, so as to heat the material 513. The makeup heater 509 further heats the material 513 to a preselected temperature, as described with drier 401. A second fluid 551 is counterflowed through the drying chamber 505 relative to the material 513 so as to remove at least part of the moisture contained in the material 513 therefrom. The second fluid 551 exits the drying chamber 505 and enters the regenerator 508 so as to transfer heat to and preheat the recirculating first fluid 512.

The principal difference between the embodiment of drier 501 as compared to drier 401 is that the second fluid 551 is not discharged into the atmosphere at a discharge 560 from the regenerator 508, but rather is discharged into a recirculation conduit 581 which recirculates the second fluid 551 back to the second fluid inlet 558 at the drying chamber 505. During passage through the recirculation conduit 581, the fluid 551 is passed through a chiller 590 which is controlled by a controller 591 to control the temperature of the second fluid 551 exiting the chiller 590 to a preselected temperature such as 70° F. Condensate formed by the cooling of the second fluid 551 in the chiller 590 is collected and discharged from the chiller 590 separate from the chilled second fluid 551.

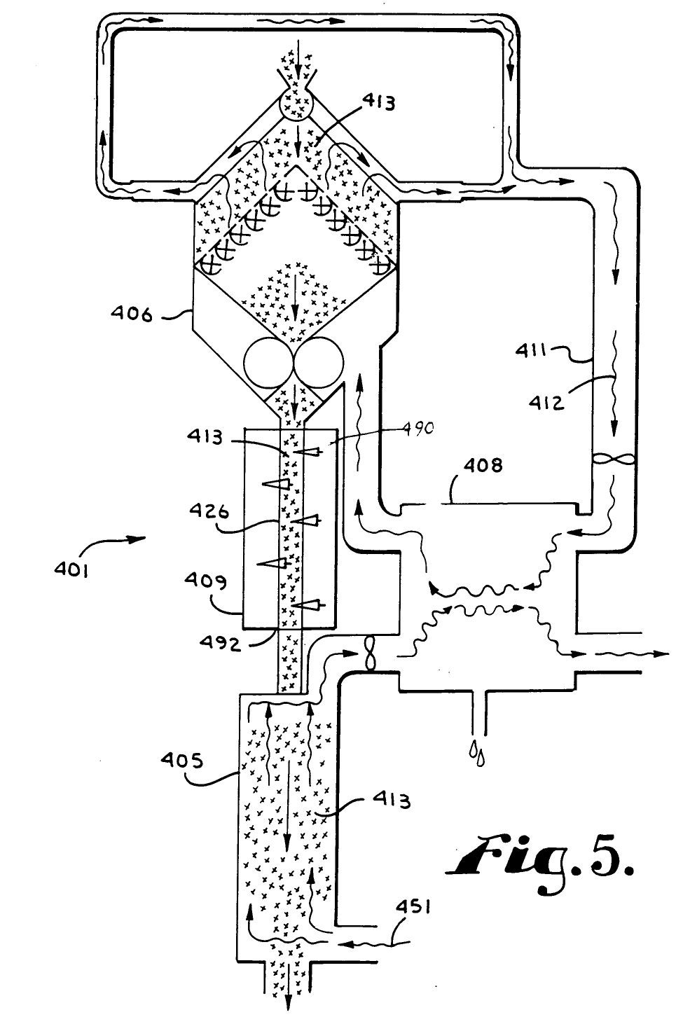

Illustrated in FIG. 7 is a sixth modified embodiment of the drier in accordance with the present invention generally represented by the reference numeral 601. The drier 601 is quite similar in many aspects to the previously described driers 401 and 201 and also to the drier 1 and corresponding detail is not discussed herein in detail, but rather references made to the description of driers 1 and 201 for further discussion regarding structure and function of the drier 601.

The drier 601 includes a drying chamber 605, a heating portion 606, a regenerator 608, a makeup heater 609 and a first fluid recirculation system 611. The recirculation system 611 circulates a first fluid 612 through the regenerator 608 so as to preheat the fluid 612 which is then conveyed to the material 613 in the heating portion 606 so as to heat the material 613 therein. The thereby heated material 613 exits the heating portion 606 and enters a chute 624 that includes the makeup heater 609 which heats the material 613 therein to a preselected temperature at the exit of the makeup heater 609. The material 613 transfers from the makeup heater 609 into the drying chamber 605 and a second drying fluid 651 is counterflowed through the material 613 to remove moisture and heat therefrom. The second fluid 651 exits the chamber 605 and enters the regenerator 608 to preheat the first fluid 612.

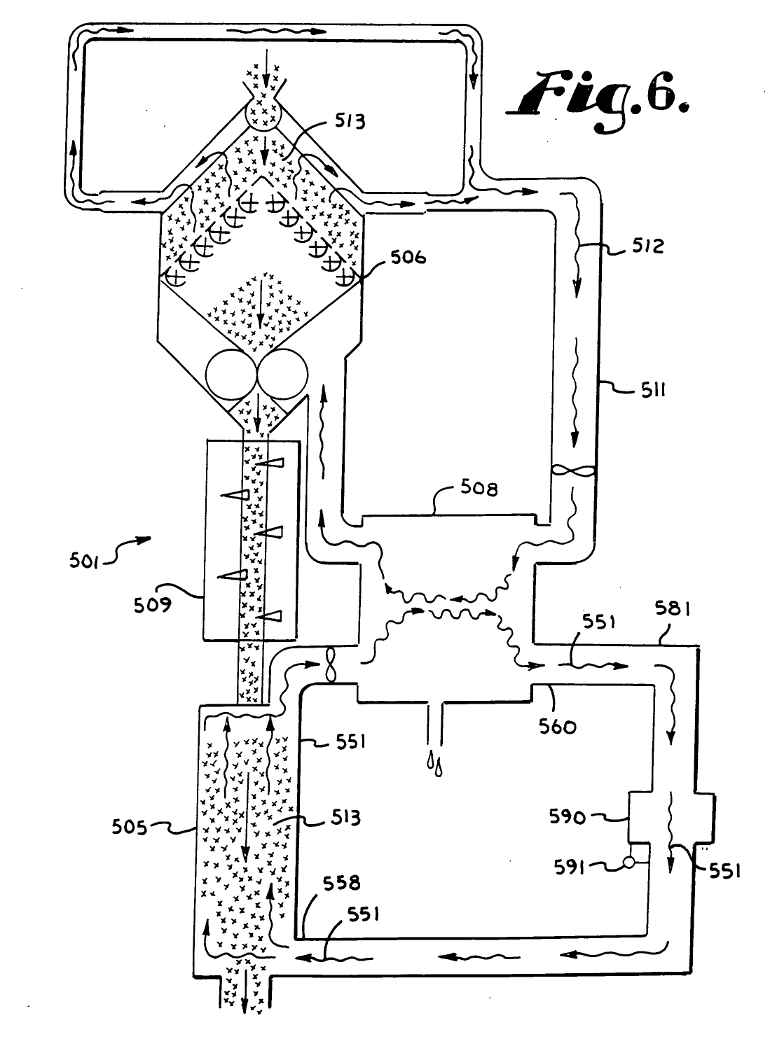

Shown in FIG. 8 is a seventh modified embodiment of a drier in accordance with the present invention which is generally indicated by the reference numeral 701. The drier 701 is similar in many aspects to the drier 601 of FIG. 7, drier 401 of FIG. 5 and drier 1 of FIG. 1. Consequently, portions of the drier 701 that are repetitive are not described in detail, but rather reference is made to the descriptions for driers 601 and 1 for further detail regarding the structure and function of the drier 701. Condensate is collected in the chiller 790 and discharged through a drain 792 or the like.

The drier 701 includes a drying chamber 705, a heating portion 706, a regenerator 708, a makeup heater 709 and a first fluid recirculation system 711. The recirculation system 711 circulates a first fluid 712 through the regenerator 708 so as to be preheated and into material 713 to be dried within the heating portion 706. The partially heated material 713 then is conveyed to the makeup heater 709 and heated to a preselected temperature after which the material 713 is transferred to the drying chamber 705. The material 713 flows through the chamber 705 from a first end 750 to a second end 758 thereof while a second fluid 751 flows counterflow to the material 713. The second fluid 751 exits the drying chamber 705 comparatively moist and warm and enters the regenerator 708 so as to preheat the first fluid 712 therein. The second fluid 751 exits the regenerator 708 at an outlet 768 into a recirculation conduit 780 which recycles the second fluid 751 back to a second fluid inlet 758 into the drying chamber 705. The recirculation conduit 780 includes a chiller 790 located intermittently therealong which is controlled by a controller 791 to cool the second fluid 751 therein to a preselected temperature, if the second fluid 751 is above that temperature.

Shown schematically in FIG. 9 is an alternative drying chamber 801 that has a plurality of compartments 802 to 804, although it is foreseen that any number of multiple chambers could be utilized. A material 806 to be dried flows generally from left to right through the chamber 801, passing through each compartment 802 to 804 in sequence. A drying fluid 808 flows overall generally counter flow to the material 806, but in each of the compartments 804 to 802 sequentially the fluid 808 flows concurrently with the material 806. Suitable baffles and airlocks are provided to allow the flows. It is foreseen that for some configurations of such a drier that a plurality of individual compartments with fixed sides may not be required, but rather sections or regions may be designed to direct flow.

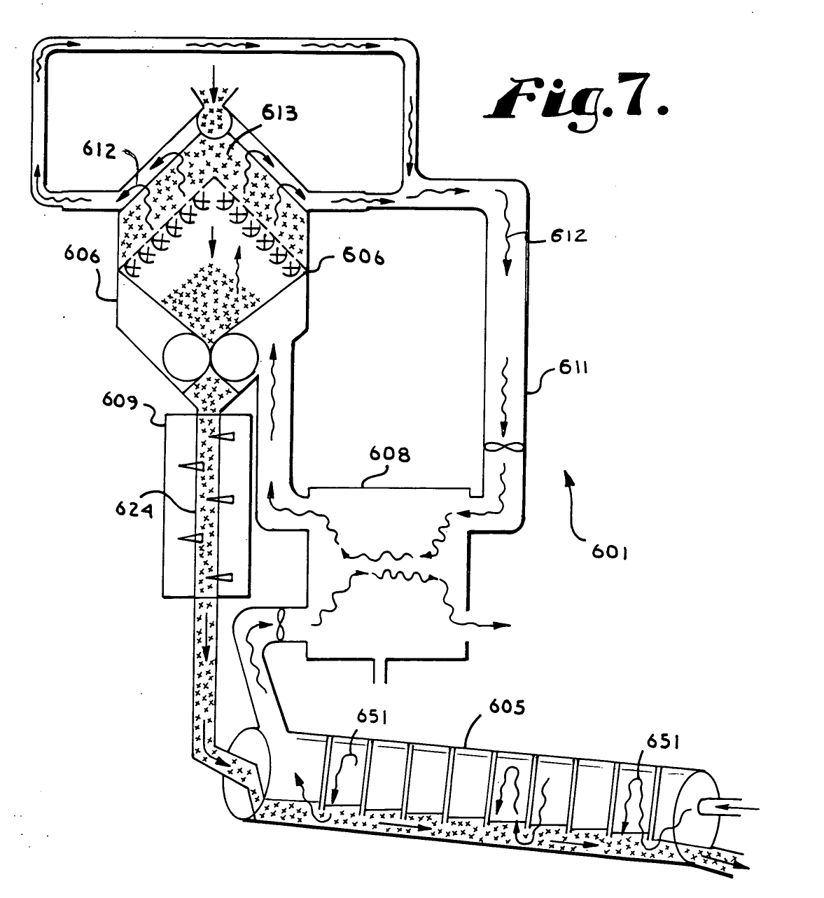

Shown schematically in FIG. 10 is an alternative drying chamber 821 that has a plurality of compartments 822 to 824, although it is foreseen that any number of multiple chambers could be utilized. A material 826 to be dried flows generally from left to right through the chamber 821, passing through each compartment 822 to 824 in sequence. A drying fluid 828 flows overall generally counter flow to the material 826, but in each of the compartments 824 to 822 in sequence the fluid 828 flows cross flow relative to the material 826. Suitable baffles and airlocks are provided to allow the flows. It is foreseen that for some configurations of such a drier that a plurality of individual compartments with fixed sides may not be required, but rather sections or regions may be designed to direct flow.

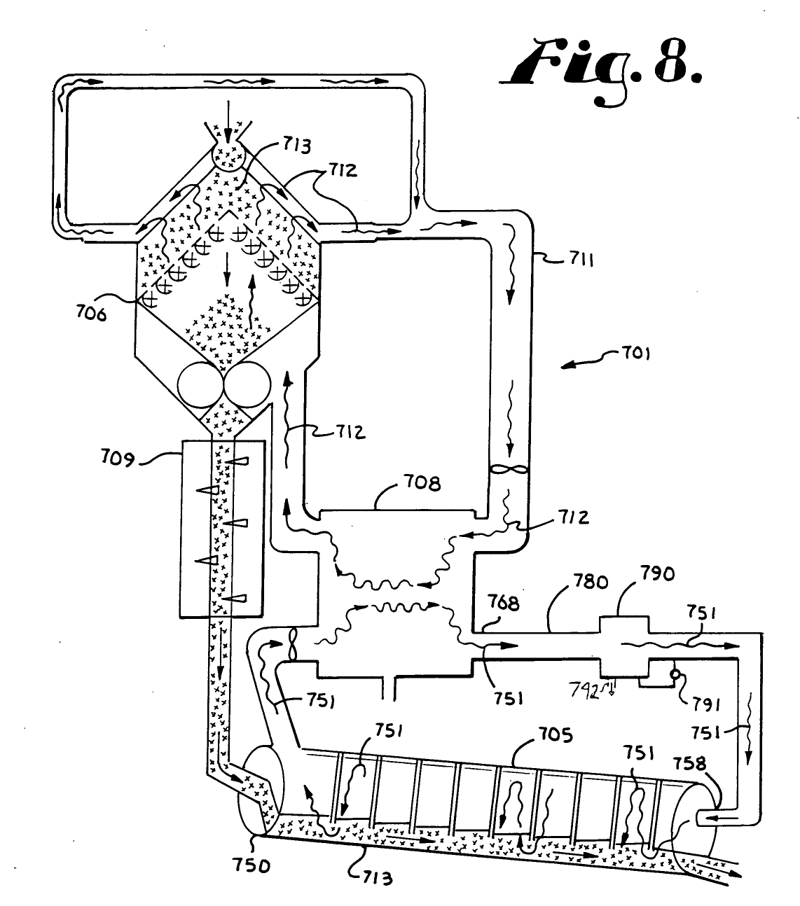

Shown schematically in FIG. 11 is an alternative drying chamber 841 that has a plurality of compartments 842 to 844, although it is foreseen that any number of multiple chambers could be utilized. A material 846 to be dried flows generally from left to right through the chamber 841, passing through each compartment 842 to 844 in sequence. A drying fluid 848 flows overall generally counter flow to the material 846, but in each of the compartments 844 to 842 the fluid 848 flows differently with respect to each other. In compartment 844 the fluid 848 flows counter currently with the material 846, in compartment 843 the fluid 848 flows cross flow with respect to the material 846 and in compartment 842 the fluid 848 flows concurrently with the material 846. Such combination of different flow paths is generally referred to herein as mixed flow and it is foreseen that such could be any combination of such flow paths in different compartments. In some instances different or mixed flow paths are combined in the same compartment. It is foreseen that unitary flow paths within individual chambers or other combinations of combined or sequential mixed flows in various chambers may be utilized in certain embodiments. It is foreseen that mixed flows of various combinations may be utilized in different regions or compartments wherein only a single flow path of fluid occurs relative to the material in each separate compartment or certain flow paths can be combined within a single compartment such as counter current and cross flow. Suitable baffles and airlocks are provided to allow the flows. It is foreseen that for some configurations of such a drier that a plurality of individual compartments with fixed sides may not be required, but rather sections or regions may be designed to direct flow. It is also foreseen that various combinations of flows can be used with respect to the first and second gases in the regeneration of the various embodiments.

Shown schematically in FIG. 12 is an alternative heating portion 851. The heating portion 851 has a plurality of compartments 852 to 854, although it is foreseen that any plural number of compartments may be utilized. Material 856 in a comparatively cool state enters the heating portion 851 passing from left to right and flows sequentially through each compartment 852 to 854. A hot fluid 858 flows overall generally counter current to the material 856, but within each of the compartments 854 to 852 in sequence the fluid flows concurrently with the material 856. Suitable baffles and airlocks are provided to allow the flow. It is foreseen that for some configurations of such a drier that a plurality of individual compartments with fixed sides may not be required, but rather sections or regions may be designed to direct flow.

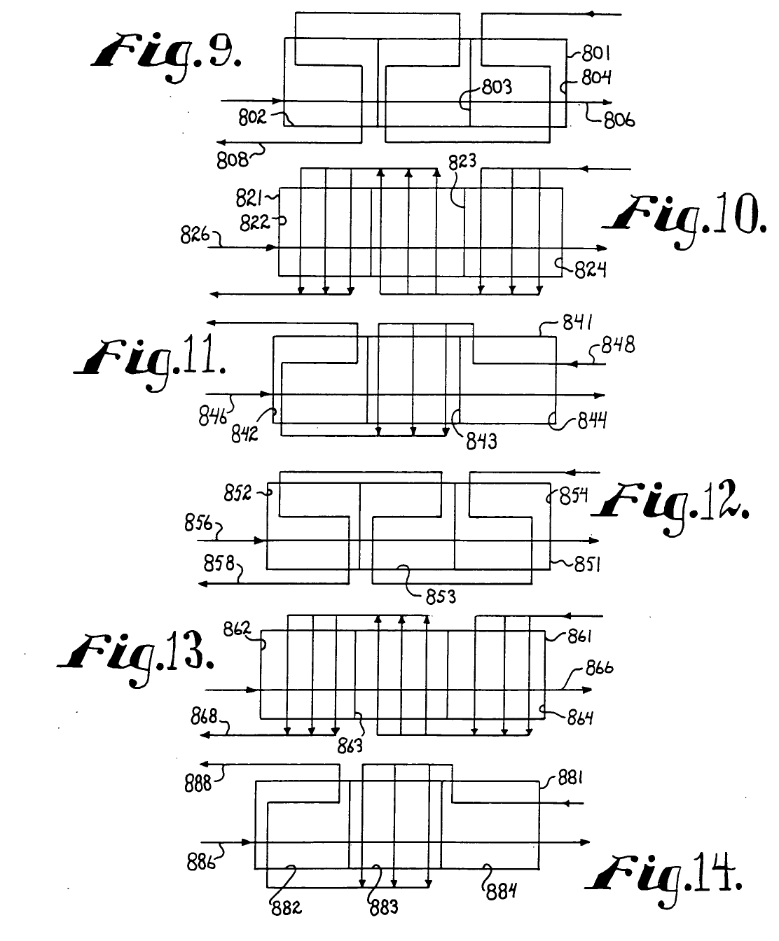

Shown schematically in FIG. 13 is an alternative heating portion 861. The heating portion 861 has a plurality of compartments 862 to 864, although it is foreseen that any plural number of compartments may be utilized. Material 866 in a comparatively cool state enters the heating portion 861 passing from left to right. A hot fluid 868 flows overall generally counter current to the material 866, but within each of the compartments 864 to 862 in sequence the fluid 868 flows cross flow through the media 866. Suitable baffles and airlocks are provided to allow the flow. It is foreseen that for some configurations of such a drier that a plurality of individual compartments with fixed sides may not be required, but rather sections or regions may be designed to direct flow.

Shown schematically in FIG. 14 is an alternative heating portion 881. The heating portion 881 has a plurality of compartments 882 to 884, although it is foreseen that any plural number of compartments may be utilized. Material 886 in a comparatively cool state enters the heating portion 881 passing from left to right. A hot fluid 888 flows overall generally counter current to the material 886, but within each compartments 884 to 882 in sequence the fluid 888 flows in mixed flow relative to the material 886. In particular in chamber 884 the fluid 888 flows counter current to the material 886, in chamber 883 the fluid 888 flows cross flow through the material 886 and in chamber 882 the fluid 888 flows concurrently with the material 886. It is foreseen that mixed flows of various combinations may be utilized in different compartments wherein only a single flow path of fluid occurs relative to the material in each separate compartment or certain flow paths can be combined within a single compartment or region such as counter current and cross flow. Suitable baffles and airlocks are provided to allow the flow. It is foreseen that for some configurations of such a drier that a plurality of individual compartments with fixed sides may not be required, but rather sections or regions may be designed to direct flow.

While a continuous counter flow process is described for the chamber and the regeneration systems in the embodiments described, it is foreseen that batch processes could be utilized using one or a series of sequential batch operations.

It is foreseen that the material to be dried may be conveyed through the chamber by other types of systems including, but not limited to augers, belts, trays and the like.

It is foreseen that the overall drying chamber can be of a wide variety including the illustrated types, as well as fluidized beds, belt, conveyer, disc, screw, tunnel and the like.

While air and nitrogen are the most likely fluids to be used in a process of this type, it is foreseen that other fluids such as argon or the like may be used. Furthermore, while particular materials to be dried have been mentioned herein, it is foreseen that a wide variety of materials may be dried, including particulates and other granular materials, powders, flakes, pastes, slurries, and solids in general. Such materials are not restricted to but may be represented by foodstuffs, such as grains, including corn, beans, dog food, mixes, meals and flours; chemicals such as clays, coals, sand; and processed materials, such as paper and the like.

It is foreseen that the drying chamber and the regenerator can be operated under vacuum or pressurized in certain embodiments.

It is foreseen that the overall counterflow of the second fluid through the material and in heat exchange with the first fluid, as well as the overall counterflow of the first fluid through the material to be dried can be accomplished in step processes wherein the flow is other or partially other than counterflow, including where the flow is countercurrent, cross-flow, counterflow and mixtures thereof, but where the overall direction of flow is counterflow.

It is foreseen that a heat pump may be added to the system, so as to extract additional latent heat of vaporization from the exhaust discharge air stream exiting the regenerator and transferring the heat preferably to a preheater or a pre-dryer ahead of the described dryer herein. It is foreseen that the heat pump could be installed so as to alternatively extract heat from an external, normally ambient air supply. It is foreseen that the heat could be transferred to other effective points within the dryer described herein, such as after the material exits the heating portion and before the material enters the drying chamber.

It is also foreseen that, although the drying of various materials through the vaporization of water and recovery of the heat of vaporization for return to the process is used in certain embodiments of the invention herein, it is foreseen that a compound to be vaporized and removed form the material may be a volatile compound other than water. This process may be applied to removal of any compound that requires heat for volatilization of a compound from the surface or interior of solid materials. The process is well adapted to situations where condensation and recovery of the volatile compound itself is of particular value.

It is to be understood that while certain forms of the present invention have been illustrated and described herein, it is not to be limited to the specific forms or arrangement of parts described and shown.

What is claimed and desired to be secured by Letters Patent is as follows:

1. A drier apparatus for drying a material utilizing a first fluid and a second fluid comprising:
a) a heating portion to operably receive the material to be dried and being configured to allow the first fluid in a heated state to flow through the material therein to heat the material to a heated state;
b) a drying chamber having first and second ends; said chamber being sized and shaped to operably receive said material in a heated state near said first end; said chamber operably receiving said second fluid in a comparatively cool state near said second end and including structure to pass said second fluid through said chamber substantially overall counter flow to said material therein such that the second fluid becomes heated to a heated state and at least partly saturated with moisture from the material;
c) a regenerator for at least partly reheating said first fluid by heat exchange of said second fluid in the heated state thereof with said first fluid without mixing said first fluid with said second fluid;
d) a first fluid recirculation system for closed circulation of said first fluid through said material and said regenerator; and
e) a makeup heater for supplying heat to the drier to replace heat lost from the drier.

2. The drier apparatus according to claim 1 wherein:
a) said drying chamber is a column chamber.

3. The drier apparatus according to claim 2 wherein:
a) said drying chamber is a downflow column chamber.

4. The drier apparatus according to claim 1 wherein:
a) said drying chamber is a rotary drum.

5. The drier apparatus according to claim 1 wherein:
a) said drying chamber is selected from the group consisting of column, rotary drum, fluidized bed, belt, conveyor, disc, screw, tray and tunnel chambers.

6. The drier apparatus according to claim 1 wherein:
a) said heater is operably located in said first fluid recirculation system between said regenerator and said heating portion.

7. The drier apparatus according to claim 1 wherein:
a) said makeup heater is operably located between said heating portion and said chamber.

8. The drier apparatus according to claim 7 wherein:
a) said makeup heater is a cross flow heater.

9. The drier apparatus according to claim 1 including:
a) a fluid conduit flow joining a second fluid discharge end of said regenerator with a second fluid receiving end of said drying chamber, so as to provide for recycling of the second fluid; and
b) a chiller device located in said fluid conduit adapted to cool the second fluid passing through said fluid conduit.

10. The drier apparatus according to claim 1 wherein:
a) said heating portion is sized, shaped and configured to allow said first fluid in the heated state to flow generally overall counterflow through the material relative to the flow of material through the heating portion.

11. A method of drying a material comprising the steps of:
a) flowing the material to be dried through a drier heating portion wherein said material is heated by flow contact with a first heated fluid;
b) thereafter passing the material through a drying chamber;
c) while said material is in said chamber, flowing a second fluid that is cooler than the material entering the chamber in a generally overall counter flow through the material such that the second fluid exits the chamber hotter and wetter in comparison to entry of the second fluid into the chamber and the material exits the chamber cooler and drier in comparison to entry of the material into the chamber;
d) thereafter reheating the first fluid by heat exchange with the second fluid exiting from the chamber; and
e) adding make up heat for heat lost.

12. The method according to claim 11 including:
a) flowing the second fluid counter current relative to the material in the drying chamber.

13. The method according to claim 11 wherein:
a) flowing said heating fluid overall generally counter current through said material in said heating portion.

14. The method according to claim 11 including the step of:
a) adding heat to the first fluid prior to flowing the first fluid into the material in the heating portion.

15. The method according to claim 11 including the step of:
a) adding heat to the material between the heating portion and the drying chamber.

16. The method according to claim 11 including the step of:
a) collecting the second fluid subsequent to utilizing the second fluid to heat the first fluid in the regenerator and returning the second fluid to the drying chamber.

17. The method according to claim 16 including the step of:
a) chilling the second fluid to a preselected temperature prior to returning the second fluid to the drying chamber.

18. The method according to claim 11 including the steps of:
a) providing a heat pump;
b) utilizing the heat pump to recover heat from the second fluid after heat exchange with the first fluid; and
c) thereafter heating the material with the heat from the heat pump.

19. The method according to claim 11 including the step of:
a) preheating the material prior to entry into the drier.

20. The method according to claim 11 including the step of:
a) flowing the material through a make up heater subsequent to flowing the material through the heating portion and prior to flowing the material into the chamber.

21. The method according to claim 11 including the step of:
a) adding make up heat to the heating fluid after the heating fluid exits the heat exchanger and before the heating fluid enters the drier heating portion.

22. In a drying process wherein a material is at least partially dried, the improvement comprising the steps of:
a) heating the material with a first fluid;
b) thereafter passing the heated material through a drying chamber substantially overall counterflow to a second fluid; and
c) thereafter utilizing the second fluid exiting the drying chamber to preheat the first fluid.

23. The process according to claim 22 including the step of:
a) supplying heat to the process to replace heat lost in the drying process.

24. A method of drying a material comprising the steps of:
a) flowing the material to be dried through a drier heating portion wherein said material is heated by flow contact with a first heated fluid;
b) thereafter passing the material through a drying chamber;
c) while said material is in said chamber, flowing a second fluid that is cooler than the material entering the chamber through the material such that the second fluid exits the chamber hotter and wetter in comparison to entry of the second fluid into the chamber and the material exits the chamber cooler and drier in comparison to entry of the material into the chamber;
d) thereafter reheating the first fluid by heat exchange with the second fluid exiting from the chamber; and
e) adding make up heat for heat lost.
